(19) United States
(12) Patent Application Publication
(10) Pub. No.: US 2022/0008892 A1
(43) Pub. Date: Jan. 13, 2022

(54) FLUID RETENTION COMPOUND

(71) Applicant: Clayton Julian Postma, Lakefield (ZA)

(72) Inventor: Clayton Julian Postma, Lakefield (ZA)

(21) Appl. No.: 17/291,820

(22) PCT Filed: Nov. 8, 2019
(86) PCT No.: PCT/ZA2019/050071

§ 371 Date: May 6, 2021

(30) Foreign Application Priority Data
Nov. 9, 2018 (ZA) 2018/07536

(51) Int. Cl. B01J 20/26; B01J 20/20; B01J 20/04; B01J 20/28; A01G 24/23; A01G 24/25; A01G 24/35

(52) U.S. Cl. CPC B01J 20/261; B01J 20/20; B01J 20/043; A01G 24/35; B01J 20/28016; A01G 24/23; A01G 24/25; B01J 20/28004

(57) ABSTRACT

A fluid retention compound and more specifically, but not exclusively, a fluid retention compound for use in agriculture, mining and construction. Retention of water using moisture absorbers is known in the art and used to improve the water-holding capacity of various media. A problem with existing moisture absorbers is the relatively ineffective rate at which water is retained and nutrients absorbed. In accordance with the invention there is provided a fluid retention compound including a superabsorbent polymer, an adsorbent, and a pH modifier. It is envisaged that the invention will provide a fluid retention compound which increases the efficacy of its water holding capacity, nutrient uptake and adsorption of other substances.

This application is the US national phase application of PCT Appln. No. PCT/ZA2019/050071, filed Nov. 8, 2019, which claims priority to ZA201807536, filed on Nov. 9, 2018, the contents of each of which is incorporated by reference.

### FIELD OF THE INVENTION

This invention relates to a fluid retention compound and more specifically, but not exclusively, to a fluid retention compound for use in agriculture, mining and construction.

### BACKGROUND TO THE INVENTION

Water scarcity is an increasing problem faced by many industries including the agricultural, mining and construction industries. Water is a valuable resource and is used for many purposes throughout these industries such as for dissolving or recovering substances, as an additive in mixtures, as a carrier of nutrition, or as a nutrient itself. Retention of water using moisture absorbers is known in the art and used to improve the water-holding capacity of various media. A problem with existing moisture absorbers is the relatively ineffective rate at which water is retained and nutrients absorbed.

### OBJECT OF THE INVENTION

It is accordingly an object of this invention to provide a fluid retention compound which, at least partially, alleviates the problem associated with the prior art or which provides a useful alternative thereto.

### SUMMARY OF THE INVENTION

In accordance with the invention there is provided a fluid retention compound comprising a superabsorbent polymer, an adsorbent, and a pH modifier.

The superabsorbent polymer is in particle form and absorbs fluid from a surrounding medium, the adsorbent is in particle form and adsorbs substances from the surrounding medium, and the pH modifier is in particle form and enhances the absorption and adsorption of the superabsorbent polymer and the adsorbent.

The compound is a mixture of a superabsorbent polymer particulate, an adsorbent particulate, and a pH modifier particulate which may be added to the medium to increase fluid retention of the medium.

The particulate may have particle sizes between 0.5 and 4 mm.

The particulate may have particle sizes between 0.5 and 1.5 mm.

The superabsorbent polymer may be in powdered or crystal form.

The superabsorbent polymer may be potassium polyacrylate or sodium polyacrylate.

The adsorbent may be activated carbon.

The activated carbon may be derived from bark; needles; sawdust; wood and biomass of trees, coconut shells, macadamia nut shells or a combination thereof.

The pH modifier may be a base.

The base may be a calcium salt.

The calcium salt may be calcium carbonate.

The fluid retention compound may contain between 10-80% potassium polyacrylate.

The fluid retention compound may contain between 10-80% activated carbon.

The fluid retention compound may contain between 10-80% calcium carbonate.

The fluid retention compound may be comprised of 70-90% potassium polyacrylate, 5-20% activated carbon, and 5-15% calcium carbonate.

The fluid retention compound may be comprised of 70% potassium polyacrylate, 20% activated carbon and 10% calcium carbonate.

### BRIEF DESCRIPTION OF THE DRAWINGS

An embodiment of the invention is described below, by way of example only, and with reference to the drawings in which:

FIG. 1 is a table of soil analysis from a first site;

FIG. 2 is a table showing the mixture ratios of soil, fertilizer and a fluid retention compound;

FIG. 3 is a graph depicting water content of saturation pastes in two soil samples treated with different amounts of a fluid retention compound;

FIG. 4 is a graph depicting the water retention capacity of two soil samples treated with different amounts of a fluid retention compound;

FIG. 5 is a table of the biomass of maize as influenced by different mixture ratios of the fluid retention compound;

FIG. 6 is a graph depicting dry biomass of maize as influenced by different mixture ratios of the fluid retention compound;

FIG. 7 is a graph depicting wet biomass of maize as influenced by different mixture ratios of the fluid retention compound;

FIG. 8 is a table of the biomass of beans as influenced by different mixture ratios of the fluid retention compound;

FIG. 9 is a graph depicting dry biomass of beans as influenced by different mixture ratios of the fluid retention compound; and

FIG. 10 is a graph depicting wet biomass of beans as influenced by different mixture ratios of the fluid retention compound.

### DETAILED DESCRIPTION OF THE DRAWINGS

Superabsorbent polymer (SAP) materials are hydrophilic networks that can absorb large amounts of water or aqueous solutions. These polymers can retain water as high as 100,000%. Superabsorbent polymers can be described as white sugar-like hygroscopic materials and are either classified as synthetic SAPs (petrochemical-based) or natural SAPs (polysaccharide- and polypeptide-based). Current SAP materials are most frequently produced from acrylic acid, its salts, and acryl amide via solution or inverse-suspension polymerization techniques. Potassium polyacrylate is an SAP which can be used in agriculture as opposed to an SAP such as sodium polyacrylate which causes soil salinisation. Potassium polyacrylate retains water by attracting hydrogen molecules to its net-like matrix which consists of polymeric chains which are linked together chemically. The potassium polyacrylate does not bind to water molecules but rather retains over 400 times its original weight in purified water due to the immense size and weight of its molecular structure. Potassium polyacrylate releases the water to the surrounding area in response to, for example, a plant's root suction through osmosis.

It is possible to improve potassium polyacrylate's efficacy through amelioration with bio-stimulants such as different carbon sources. This will result in improved water holding capacity of soil as well as increased nutrient uptake by plants.

The three components in the fluid retention compound each contribute to the improved water holding capacity of soil as well as the increased uptake of nutrients by plants. The activated carbon serves as an adsorbent which accumulates substances on its surface such as water insoluble inorganic matter, and as an absorbent which retains water and nutrients through macro, micro and meso pores on the surface of the activated carbon granules. The activated carbon may for instance retain gold particles on its surface as well as absorb water through its pores when used in the mining industry. The activated carbon also aids in increasing the pH of the environment. The pH modifier, specifically calcium carbonate, however acts as the main pH stabiliser of the compound by controlling the pH in soils with a typically high acidity resulting from sustained fertilisation in the agricultural industry. The membrane of the potassium polyacrylate expands and retracts as it absorbs and releases water. This membrane adjustability of the potassium polyacrylate in the fluid retention compound ensures that the compound may be re-used several times. The potassium polyacrylate's reabsorption quality is however affected by salts in the soil. The salts break down the bonds of the potassium polyacrylate which is responsible for the reabsorption. The calcium carbonate thus serves as a preservative of these bonds by increasing the pH levels of the soil with which the compound is mixed and decreasing the negative effect of the salt in the soil on the potassium polyacrylate's membrane. The optimum ratio of the three components to each other is preferred to be 7:2:1 of potassium polyacrylate to activated carbon to calcium carbonate.

The fluid retention compound may be used in applications such as mining where it could assist with the absorption of water and recovery of gold or other metals or in construction as an additive in concrete mixtures to assist with the curing of concrete. The fluid retention compound will reduce curing time and improve the overall strength and durability of concrete mixtures to achieve superior hardness over traditional concrete mixtures. For agricultural purposes, more chemicals, additives, binders or fillers may be added to the fluid retention compound mixture depending on the soil type. In agriculture, the compound is utilised for increasing water retention and nutrients, reducing water consumption, reducing irrigation cycles, and storing water around roots.

Application of the fluid retention compound may be carried out by manually or mechanically spreading the dry, granular compound onto soil or pre-mixing granules with water to be sprayed onto soil. The dry granules or spray is mixed into the soil until the desired depth and/or consistency is reached. The spray may also be injected into the soil or growth medium.

Dosage of the fluid retention compound is determined by soil type, plant type, rainfall, and irrigation/watering cycles. In agriculture, the dosage is typically a minimum of 0.1-100 gram per square metre. In construction, 1-1000 grams could be added per ton of concrete depending on the formulation of the components and desired result or performance. A typical dosage in mining would be 750 to 1000 grams per 200 to 400 litres of water to be absorbed or contained depending of the desired result or performance, pH levels of water and metals that are to be recovered.

In an efficacy experiment, a fluid retention compound comprising potassium polyacrylate, activated carbon and calcium carbonate was evaluated to determine the most effective mixture ratio which will result in the highest amount of overall biomass production of beans and maize. Any possible phyto-toxicity effects of the fluid retention compound were also evaluated.

Materials and Methods

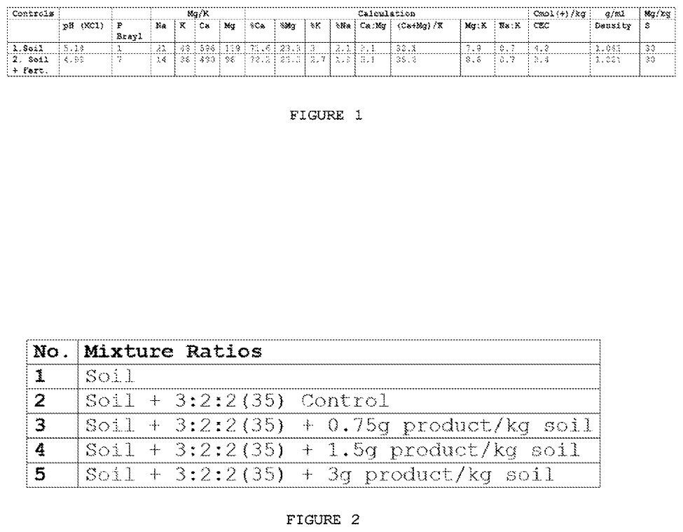

A loamy sand (from a first site) and a sandy clay loam (from a second site) soil samples were used for the pre-evaluation of the fluid retention compound. A soil analysis of the first soil sample, with and without fertilizer, is shown in FIG. 1.

Pre-Evaluation Laboratory Test

Prior to a greenhouse trial, a laboratory test was done in order to evaluate the influence of the compound on the physical properties of soil water retention.

Influence on Water Saturation Percentage of the Soils

Soil samples were prepared with different amounts (0 gram; 1 gram; and 2 gram) of the fluid retention compound to a 300 gram soil sample. For each amount a saturation paste was prepared, and the water requirement noted.

Influence on the Water Holding Capacity of Soil

Perspex columns were filled with the two soil samples and a standard volume of water applied to the soil. After two days the length of the wetted part of the column was measured. Based on the diameter and volume used, the mm water that was applied was calculated. Based on the length of columns that were wetted with the specific volume/mm of water, the amount of water to wet a soil profile to a depth of one metre was calculated and expressed as mm water/m soil.

Greenhouse Trial

The fluid retention compound's ingredients may be dry mixed or blended using equipment such as a ribbon blender. A chemical or organic binder could be added to form a larger particle or granule, requiring a different processing method. Based on the recommended amounts as prescribed for the compound, mixture ratios were created with a standard fertilizer, together with half, full and double the recommended amounts. Together with these mixture ratios a reference mixture which received only fertilizer was included. The different mixture ratios are as set out in FIG. 2. The required amount of the compound was mixed into the soil prior to planting.

Trial Layout

Pots containing 6 kg of soil were treated as follows: before planting, the appropriate amount of the fluid retention compound was mixed with the soil of each pot and at planting, 2 grams/pot of a 3:2:2(35) bulk blended mixture was applied as a band in the centre of the pot, 4 cm deep. During the trial period the daily irrigation was interrupted from time to time to stress the plants until they showed visible signs of wilting. The severity of the wilting was noted. Each mixture ration was applied to four different plants. At harvesting each plant was cut above the soil, weighed (wet mass), oven dried at 65° C. and weighed again (dry mass).

Results and Discussions

Pre-Evaluation Laboratory Test

Influence on Water Saturation Percentage of the Soils

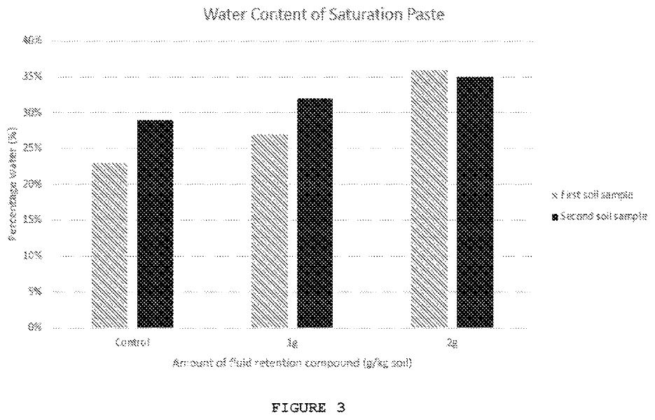

FIG. 3 shows the water content of the saturation pastes which increased significantly when increasing amounts of the compound was added to the soil. It could also be concluded that the water content at saturation of the first site's soil increased more than the second site's soil.

Influence on the Water Holding Capacity of Soil

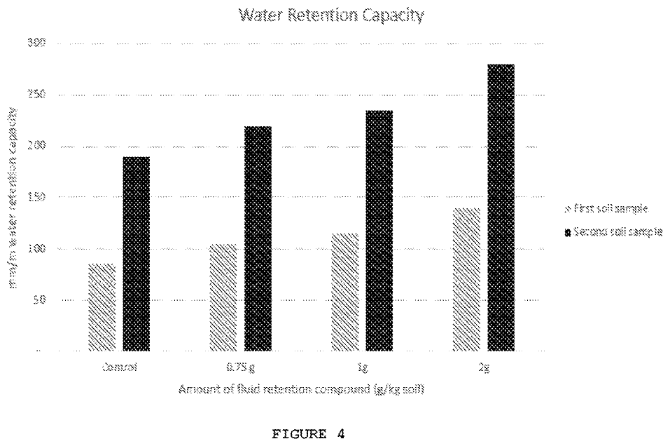

From the data in FIG. 4, it was obvious that the volume water required to wet soil to one-meter depth increased when increasing amounts of the fluid retention compound was applied to the soil.

Maize Biomass Yield

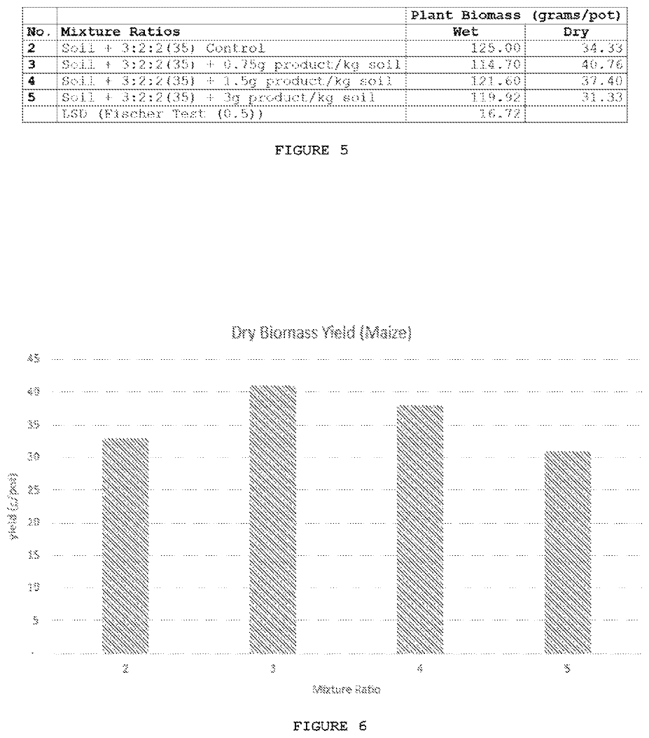

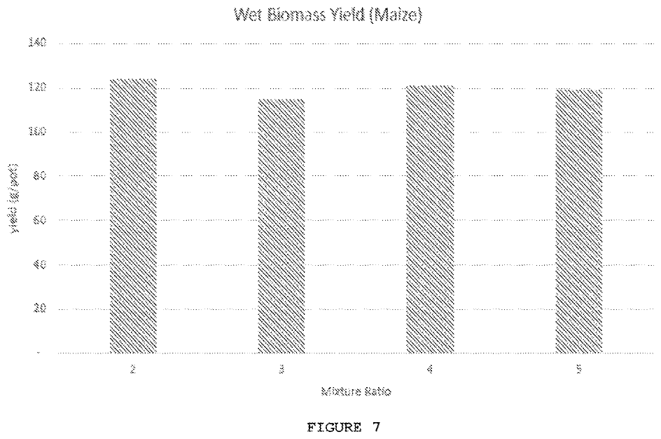

FIGS. 5, 6, and 7 show the biomass yields of maize treated with the different mixture ratios. The second mixture ratio received only the basic fertilizer application and was used as a control. In this trial the biomass of the different treatments was not significantly different from one another.

Bean Biomass Yield

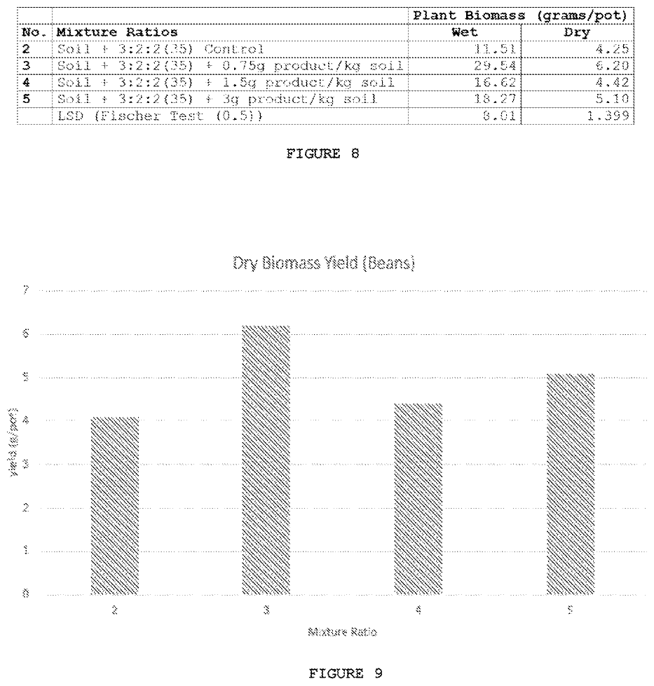

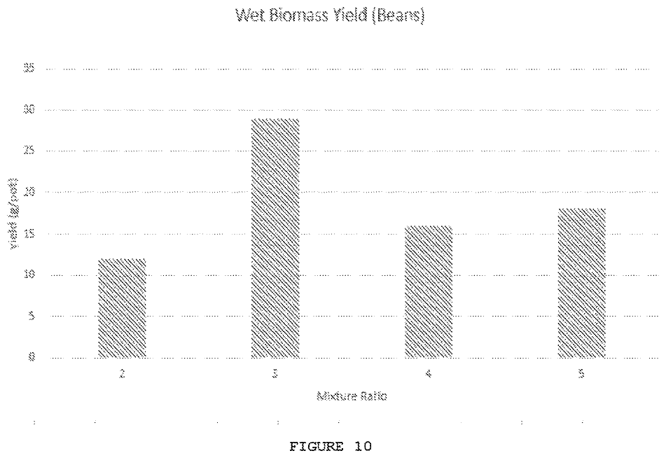

FIGS. 8, 9, and 10 show the biomass yields of beans treated with the different mixture ratios. The second mixture ratio received only the basic fertilizer application and was used as a control. In this trial the biomass yield was statistically lower than the average, indicating that there was a benefit even at the lowest mixture ratio. The yield improved significantly when only half the recommended mixture ratio was applied. This indicates better water holding capacity and less stress on the plants when irrigation was interrupted. Increased mixture ratios did not benefit the plants.

Conclusion

The maize yield did not show any benefit when increased mixture ratios were applied since the maize was left to harvest along with the beans. The maize grows faster than the beans and if the maize was harvested earlier, the effects of the fluid retention compound would have been evident in these crops as well.

Bean yield was significantly higher at the lower mixture ratio, due to the better water holding capacity of the soil when the fluid retention compound was incorporated into the soil. Due to the lower biomass production of the beans compared to the maize, the exploitation of the soil nutritional supply was not negatively impacted by the beans. If the maize, being a faster grower, was harvested earlier, the same beneficial effect of the fluid retention compound would have been obtained. No detrimental phyto-toxicity effects were observed.

It is envisaged that the invention will provide a fluid retention compound which increases the efficacy of its water holding capacity, nutrient uptake and adsorption of other substances.

The invention is not limited to the precise details as described herein. For example, instead of use in the agriculture, mining or construction industries, the fluid retention compound may be used in any industry where the properties of the compound would serve to be beneficial. Instead of the compound being used for agricultural farming, it may be used to grow seeds, lawns, turfs, flower beds, vertical gardens/hanging baskets, aeroponics, pot plants, vegetables, fruit trees and shrubs.

What is claimed:

1. A fluid retention compound comprising a superabsorbent polymer, an adsorbent, and a pH modifier.

2. The fluid retention compound of claim 1 wherein the superabsorbent polymer is in particle form and absorbs fluid from a surrounding medium, the adsorbent is in particle form and adsorbs substances from the surrounding medium, and the pH modifier is in particle form and enhances the absorption and adsorption of the superabsorbent polymer and the adsorbent.

3. The fluid retention compound of claim 2 wherein the compound is a mixture of a superabsorbent polymer particulate, an adsorbent particulate, and a pH modifier particulate which is added to the medium to increase fluid retention of the medium.

4. The fluid retention compound of claim 3 wherein the particulate has a particle size between 0.5 and 4 mm.

5. The fluid retention compound of claim 3 wherein the particulate has a particle size between 0.5 and 1.5 mm.

6. The fluid retention compound of claim 1 wherein the superabsorbent polymer is in powdered form.

7. The fluid retention compound of claim 1 wherein the superabsorbent polymer is in crystal form.

8. The fluid retention compound of claim 1 wherein the superabsorbent polymer is potassium polyacrylate.

9. The fluid retention compound of claim 1 wherein the superabsorbent polymer is sodium polyacrylate.

10. The fluid retention compound of claim 1 wherein the adsorbent is activated carbon.

11. The fluid retention compound of claim 10 wherein the activated carbon is derived from the bark; needles; sawdust; and wood of a tree.

12. The fluid retention compound of claim 10 wherein the activated carbon is derived from biomass of a tree.

13. The fluid retention compound of claim 10 wherein the activated carbon is derived from coconut shells.

14. The fluid retention compound of claim 10 wherein the activated carbon is derived from macadamia nut shells.

15. The fluid retention compound of claim 10 wherein the activated carbon is derived from a combination of at least two sources, including the bark; needles; sawdust; and wood of a tree, biomass of a tree, coconut shells, and macadamia nut shells.

16. The fluid retention compound of claim 1 wherein the pH modifier is a base.

17. The fluid retention compound of claim 16 wherein the base is a calcium salt.

18. The fluid retention compound of claim 17 wherein the calcium salt is calcium carbonate.

19. The fluid retention compound of claim 1 wherein the superabsorbent polymer is potassium polyacrylate, the adsorbent is activated carbon, the pH modifier is calcium carbonate, and the fluid retention compound is comprised of between 70% and 90% potassium polyacrylate, between 5% and 25% activated carbon and between 5% and 15% calcium carbonate.

20. The fluid retention compound of claim 1 wherein the superabsorbent polymer is potassium polyacrylate, the adsorbent is activated carbon, the pH modifier is calcium carbonate, and the fluid retention compound is comprised of 70% potassium polyacrylate, 20% activated carbon and 10% calcium carbonate.
